(19) United States
(12) Patent Application Publication
(10) Pub. No.: US 2007/0131176 A1
(43) Pub. Date: Jun. 14, 2007

(54) Connector and replacement leash strap for retractable leash

(75) Inventors: David W. Jensen, North Conway, NH (US); J. Scott Badger, Jackson, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(73) Assignee: LUPINE, INC.

(21) Appl. No.: 11/302,791

(22) Filed: Dec. 14, 2005

(51) Int. Cl. A01K 27/00

(52) U.S. Cl. 119/796

(57) ABSTRACT

A leash repair kit is provided for a retractable leash of a type having a housing and a cord retractably arranged within the housing. The cord includes a free end which extends out of the housing. The leash repair kit includes a leash strap and a fastening apparatus for removably joining together the cord and the leash strap. In further aspects, a retractable leash, connector assemblyand method of replacing an external leash portion of a retractable leash are provided.

### FIELD OF THE INVENTION

The present invention relates to pet leashes and, more particularly, to a replacement leash assembly for a retractable leash, a connector therefore, and a method and retractable leash employing the same.

### BACKGROUND OF THE INVENTION

The conventional retractable pet leash (also called “Stop and Lock” leash) has become very popular with pet owners in recent years. Such retractable pet leashes come in various sizes, depending on various parameters, such as the strength required to adequately restrain the particular pet, the strength of the retracting-feed mechanism, or the amount of maximum lead that is desired. The retractable pet leash conventionally comprises a housing, which houses both a spooled lead and a mechanism for spooling and releasing the spooled lead, and a leash strap that attaches at one end to the lead and at the other end to a collar on the pet. The spooled lead portion is typically a woven, high-strength cord having a generally circular cross-sectional shape of relatively small diameter. Typically, the leash cord is highly flexible, so that it winds easily onto the spool when retracted. The leash strap, on the other hand, is typically a relatively flat strip, usually formed of nylon or other fabric webbing.

On the conventional retractable pet leash, the leash strap is permanently attached to the lead. Because the leash strap is always exterior to the housing it is subject to being chewed by pets, particularly dogs. Thus, with time, the leash becomes impaired and must be replaced. Commonly, the entire retractable pet leash has to be replaced when the leash strap is chewed or damaged to the extent that it no longer provides a secure restraint for the pet. Retractable pet leashes are relatively expensive and, because of the cost, pet owners tend to avoid replacement as long as possible. This disincentive to replace the leash in a timely manner affects the safety of such leashes since pet owners may continue to use damaged or impaired pet leashes.

Another disadvantage of the conventional, retractable pet leash is the lack of choice of leash strap color and style. Some pet owners may enjoy using leash straps that are visually appealing to them. For example, a pet owner may wish to have a strap that coordinates well with a certain color scheme, matches a collar of the pet, or that otherwise has a certain pattern. In some instances, a pet owner may wish to have a set of straps variety of styles, colors and/or patterns from which to choose on any particular day. Presently, the pet owner is limited to the colors and patterns that the manufacturer of the retractable pet leash offers.

None of the retractable pet leashes available today are provided with a connector that will enable quick and easy replacement of the leash strap. U.S. Patent Application Publication 2001/0037774 A1 (DeBien; November 2001) discloses a retractable pet leash that is provided with a quick-release coupling and a release activation assembly, the purpose of which is to allow an animal handler to release a tethered animal at a remote location. The quick-release coupling and release assembly cooperate to disengage the pet leash from the collar of the animal. The disclosure does not, however, address the matter of allowing one to replace or exchange a leash strap that is connected to the lead of the retractable pet leash.

What is needed, therefore, is a leash strap that is adapted to easily attach to the retractable lead cord of a conventional retractable leash. What is further needed is a leash repair kit that provides a means for replacing or exchanging the leash strap that is attached to the retractable leash. The present invention contemplates an improved leash strap and connector which overcome the above-referenced limitations and others.

### SUMMARY OF THE INVENTION

In one aspect, a leash repair kit is provided for a retractable leash of a type having a housing and a cord retractably arranged within the housing. The cord includes a free end which extends out of the housing. The leash repair kit includes a leash strap and a fastening apparatus for removably joining together the cord and the leash strap. In further aspects, a retractable leash, connector assembly, and method of replacing an external leash portion of a retractable leash are provided.

In a further aspect, a retractable leash includes a housing, a cord retractably arranged within the housing, and a leash strap. The cord has a free end which extends out of the housing. A fastening apparatus removably joins together the cord and a leash strap.

In another aspect, a connector for retractable leash of a type having a housing and a cord retractably arranged within the housing includes a first fastener adapted to be permanently attached to a external leash strap and a second fastener adapted to be removably attached to a free end of the cord.

In still another aspect, a connector assembly includes an elongate hook member forming a hook at a first end and having an opening formed in a second end opposite the first end. A mounting plate is disposed intermediate the hook and opening. A closure carrier is mounted to a first surface of the mounting plate and a closure member is slidably carried on the closure carrier and is movable between a closed position and an open position.

In yet another aspect, a method is provided for replacing an external leash portion of a retractable leash of type having a housing and a cord retractably arranged within the housing, the cord having a free end which extends out of the housing leash. A replacement leash assembly, including a replacement leash and a fastening apparatus for removably joining together the cord and the replacement leash; is provided. The external leash portion to be replaced is removed and a loop is formed in the cord free end. The loop is then removably attached to the fastening apparatus.

One advantage of the present invention is that it provides quick and easy replacement or exchange of the leash strap portion of a conventional retractable pet leash. In this manner, a retractable leash having a damaged leash strap may be repaired without incurring the expense of replacing the entire retractable leash.

Another advantage of the present invention resides in the ability of the user to modify a retractable leash, e.g., to provide a desired aesthetic appearance. Since the present invention provides a releasable connection between the leash cord and the leash strap, it becomes practical for a pet owner to have a number of leash straps, all of which may be quickly and easily interchanged, depending on the color, style, and/or pattern of the leash that is desired for a particular activity or event.

Other benefits and advantages of the present invention will become apparent to those skilled in the art upon a reading and understanding of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 shows a conventional retractable pet leash which may be adapted for use with the present invention.

FIG. 2 is an enlarged view of a stop member providing a transition between a retractable cord portion and an external leash strap of the conventional retractable leash shown in FIG. 1.

FIG. 3 shows an alternate conventional retractable pet leash which may be adapted for use with the present invention.

FIG. 4 shows a leash repair or replacement kit according an exemplary embodiment the invention.

FIG. 5 is an enlarged view of the exemplary connector assembly portion of the leash repair/replacement kit shown in FIG. 4.

FIGS. 6 and 7 illustrate connector assembly embodiments similar to the embodiment shown in FIG. 5, but adapted for use with leash strap portions of varying widths and/or thicknesses.

FIG. 8 depicts the connector assembly shown in FIG. 5, with the releasable connector shown in the open or retracted position.

FIG. 9 is a side cross-sectional view taken along the lines 9--9 shown in FIG. 5.

FIG. 10 is an exploded view of the connector assembly shown in FIG. 5.

FIGS. 11 and 12 illustrate a method of repairing a retractable leash having a damaged leash strap or otherwise replacing the external leash strap of a retractable leash.

FIG. 13 illustrates an alternative exemplary embodiment of the present invention.

### DETAILED DESCRIPTION OF THE INVENTION

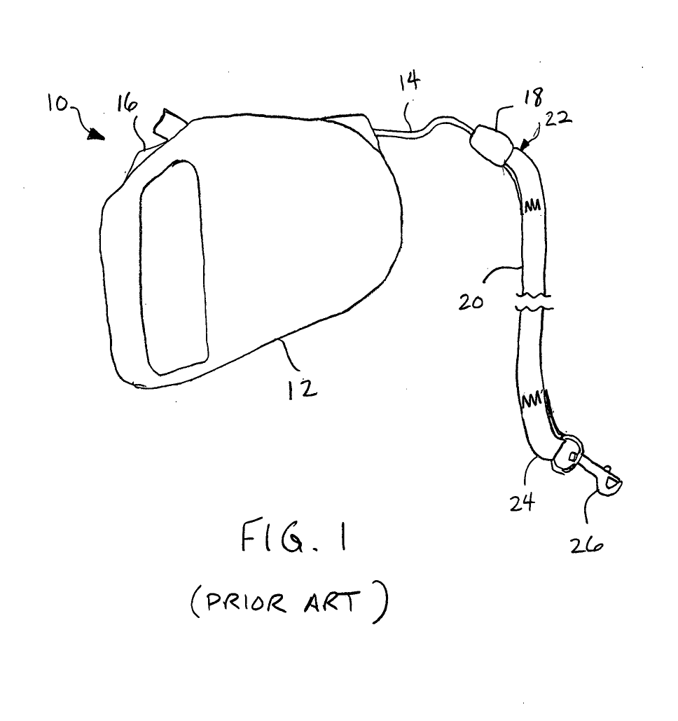

Referring to the drawings, wherein like reference numerals refer to like or analogous components throughout the several views, FIG. 1 illustrates a conventional retractable pet leash 10 of a type preferred for use in connection with the present invention. The leash 10 includes a housing 12 enclosing a spooled cord 14. The spooled cord 14 may be wound and unwound to form a leash of varying length. Commonly, one or more break buttons 16 may be provided to prevent winding or unwinding of the cord 14, e.g., to maintain the retractable leash 10 at a desired length. In the depicted embodiment, a stop member 18 provides the transition between the retractable cord 14 and a first end 22 of an external leash strap portion 20.

The leash strap 20 may suitably be made from any natural or synthetic textile or fabric material, including without limitation, cotton, canvas, wool, leather, polymer material such as nylon, vinyl, polyester, polypropylene, and so forth, as well combinations of such materials.

The stop member 18 abuts the housing 12 when the cord 14 is fully retracted into the housing 12. Since the leash strap portion 20 remains exterior to the housing at all times, it is subject to chewing by the pet. A second, free end 24 of the leash strap 20 includes a connector 26 for releasable connection to a collar, harness, etc., of a pet.

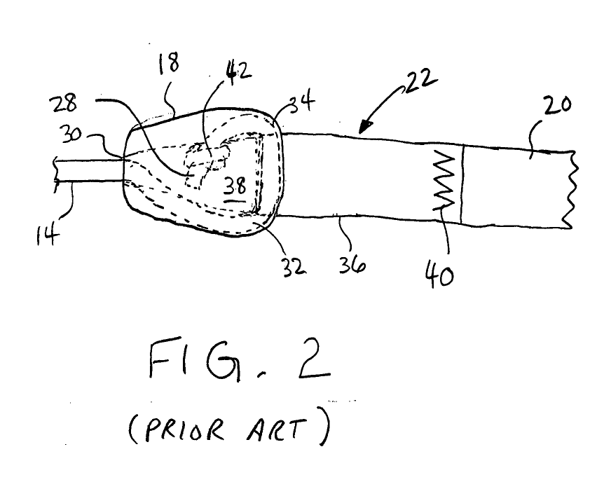

Referring now to FIG. 2, there appears an enlarged view of the stop member 18. The distal end 28 of the cord 14 passes through an opening 30 in the stop 18 and forms a loop 32, e.g., within a channel 34 formed on the stop member 18. The loop 32 passes through a loop 36 formed in the end 22 of the leash strap end 20.

The loop 36 is typically permanently formed, e.g., via stitching 40 or other generally permanent attachment means. The free end 28 of the cord 14 then passes into an interior opening 38 in the stop member 18 and may be secured therein via a knot 42 or other stop or attachment means. Leashes of the type illustrated in this embodiment are commercially available from Flexi USA, Inc., of Cincinnati, Ohio.

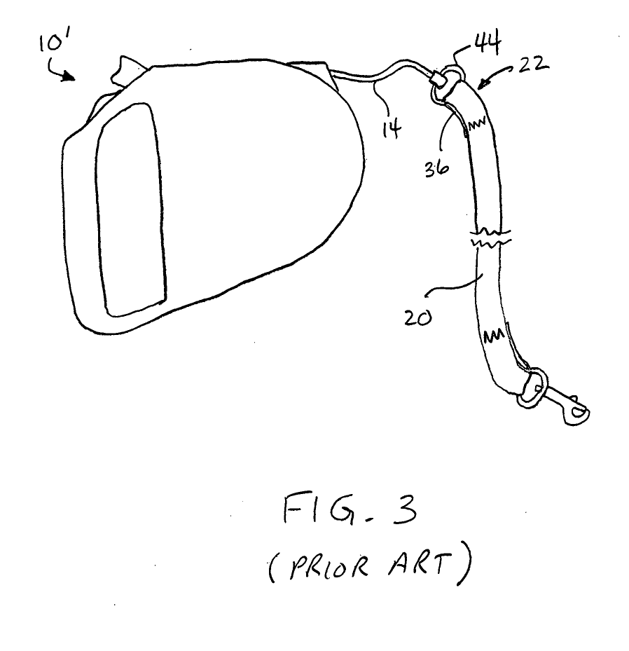

It will be recognized that the present invention may be employed with any type of retractable leash wherein the cord 14 terminates in a loop, ring, or the like, or otherwise may be provided with a loop, ring, or the like. For example, in reference now to FIG. 3, a retractable leash 10′includes a retractable cord 14 attached to an external leash strap portion 20 via a ring 44. The ring 44 passes through a loop 36 formed at the proximal end 22 of the leash strap 20. Other means for forming and/or attaching a loop or ring at the end of the retractable cord 14 are also contemplated.

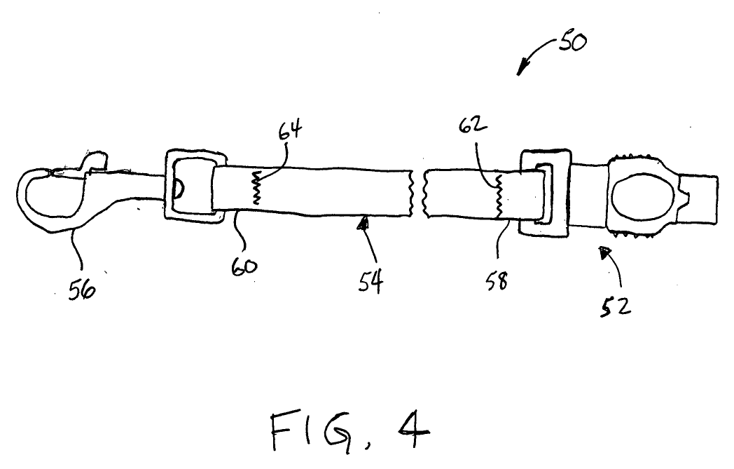

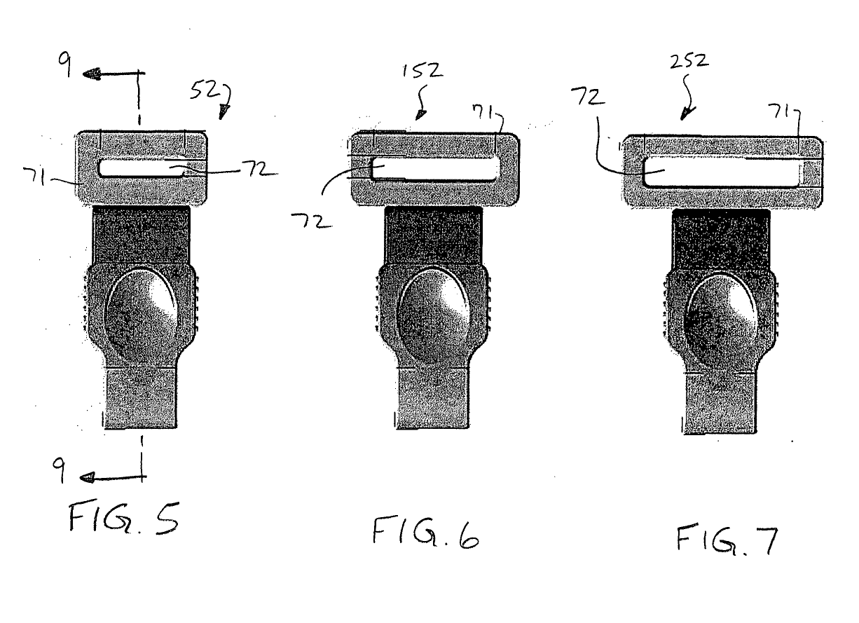

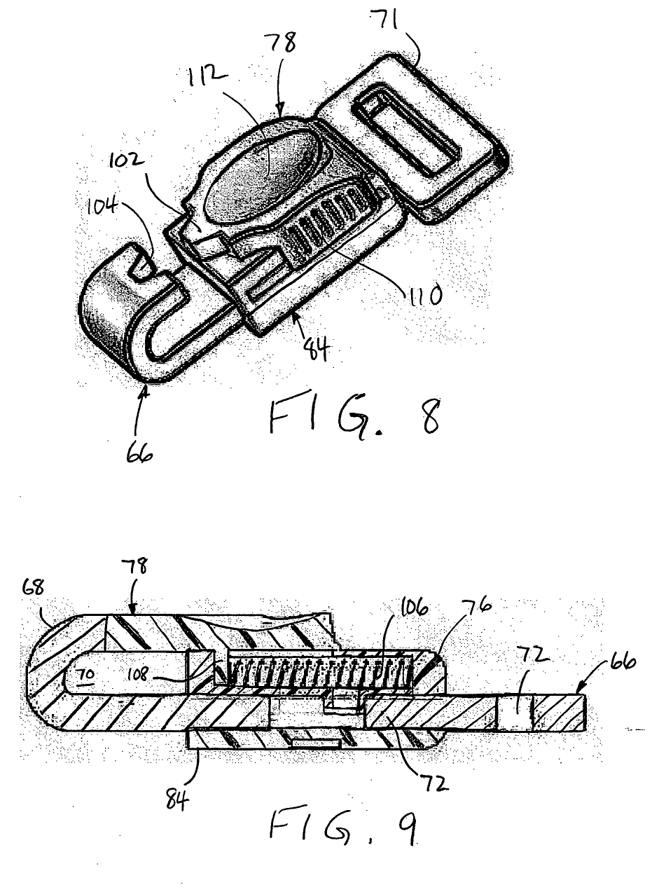

The leash replacement/repair kit of the present invention includes a connector assembly which includes a permanently attached replacement leash strap and a releasable or non-permanent connector for releasably attaching the free end of the retractable cord 14. Referring now to FIG. 4, there is shown an exemplary embodiment of a leash replacement/repair kit 50, which includes a connector assembly 52, a leash strap portion 54, and a connector 56 for releasably attaching to a collar or harness of a pet. The leash strap portion 54 includes a loops 58 and 60 formed at opposite ends of the leash strap portion 54 and each is generally permanently formed, e.g., via stitching 62 and 64, respectively. Other generally permanent means of attachment are additionally or alternatively contemplated.

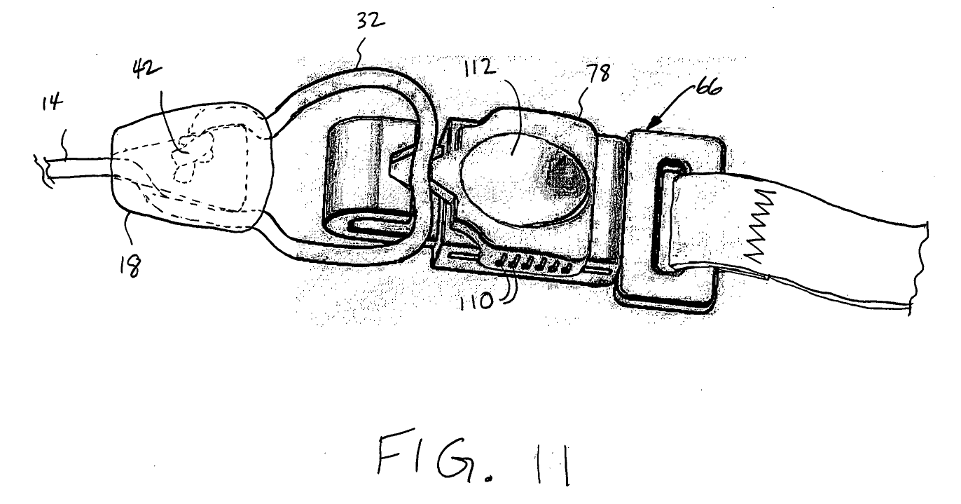

With reference now to FIGS. 5 and 8-10, the connector assembly 52 includes a generally hook-shaped member having 66 having a hook 68 at a first end and defining a channel or opening 70. An eyelet end 71 having an opening or slot 72 is formed in a second end opposite the first end, and a main body portion 74 disposed between the first and second ends. The hook shaped member is preferably formed of a rigid material such as a metal or metal alloy, polymer material, or the like. A tension force applied to the fastening unit 52 during normal operation will not tend to cause opening of the connector assembly 52. The loop 58 in the leash strap 54 is formed by first passing an end of the leash strap through the slot 72 and folding the end back upon itself and permanently securing via stitching 40 or other generally permanent attachment means. Other means for generally permanently fixing the loop 58 include, without limitation, weaving, braiding, riveting, stapling, clamping, bolting, gluing or adhesive bonding, thermal fusing or bonding and the like.

As illustrated in FIGS. 6 and 7, there are shown connector assemblies, 152 and 252, respectively, which vary in that the hook member 66 is formed with a eyelet end 71 having a slot 72 of an alternative size. In this manner, the slot 72 may accommodate varying widths and/or thicknesses of web or strap material forming the replacement leash strap 54, e.g., to accommodate different size retractable leashes and pets.

A carrier member 76 slidably carries a closure member 78 thereon. The carrier 76 is secured to the upper surface of the main body portion 74 of the hook member 66 via one or more (four in the depicted embodiment) mounting bosses 80 which pass through notches 82 in the main body 74. Alternatively, the notches 82 may be through holes or apertures.

A base 84 includes a pair of opposing and upstanding side walls 86 defining an axial channel 88. The main body 74 is received within the channel 88. The base 84 includes one or more openings 90, each of which is aligned with a corresponding one of the mounting bosses 80 and notches or apertures 82. One or more threaded fasteners 92 pass through the one or more openings 90 and openings or notches 82 and rotatably engage the mounting bosses 80, thereby clamping the hook member 66 between the base 84 and the carrier 76.

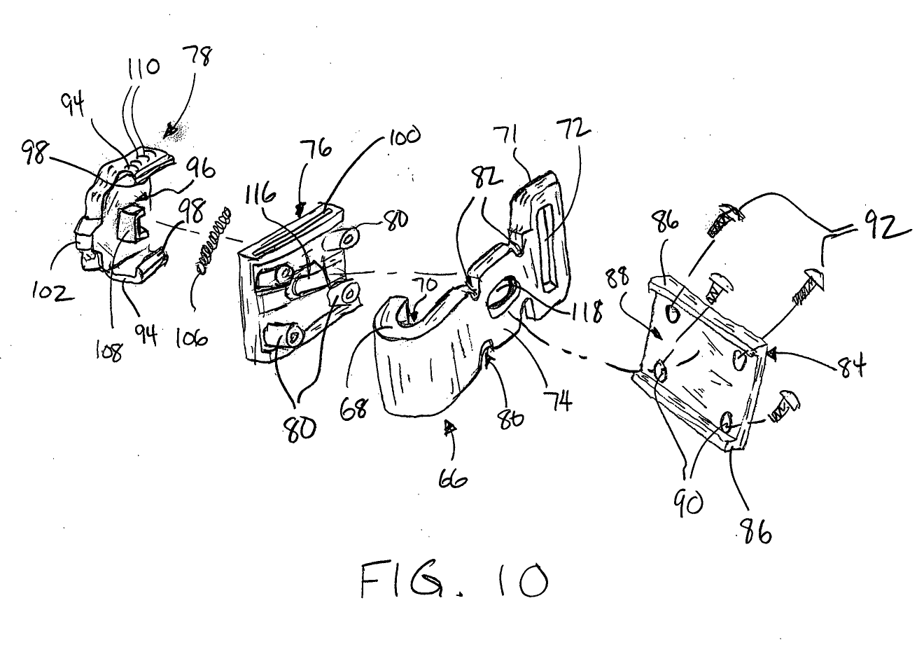

The closure member 78 includes a pair of opposing vertically extending side walls 94, defining a channel 96 therebetween. Each of the vertically extending sidewalls 94 includes an axially aligned and inwardly extending rail or rib 98. The rails 98 slidably engage axially extending channels 100 formed in the carrier 76 to secure the closure 78 to the carrier 76 while allowing relative axial movement therebetween. In this manner, the closure 78 is manually slidable between a closed position in which it abuts the hook portion 68 (see FIG. 5) and an open position (see FIG. 8). In the depicted preferred embodiment, the closure member 78 includes a protrusion 102 which engages a complimentary opening or recess 104 when the closure is in the closed position to reduce the chance of unintended separation of the closure 78 and the hook 68. FIG. 13 illustrates an alternative exemplary connector assembly embodiment 352 further having an optional inward protrusion or deformation 114 provided within the channel portion 70 to further resist unintended separation between the cord 14 and the connector assembly.

A spring 106 is captured between the carrier 76 and the closure 78. The spring 106 engages a downwardly extending protrusion 108 formed on the closure 78 and biases the closure 78 toward the closed position. The closure 78 is moved to the open position by manually sliding the closure member 78 against the urging of the spring 106. The spring 106 may be a cylindrical or conical coil spring. Alternatively, other resilient, deformable members are contemplated for use in place of the spring 106. A protrusion 116 may be provided and received in an aligned opening 118 formed in the central portion 74 of the hook member 66. Preferably, ergonomic features, such as textured or ribbed surfaces 110 or depression 112 may be provided to assist the user in manually engaging the closure member 78.

To use the replacement leash assembly 50 of the present invention to replace a preexisting leash strap portion 20 of a retractable leash 10 as shown in FIG. 1, the preexisting leash strap 20 is first removed. This may be done by severing the loop 36. As noted above, the unit 50 may be used to replace a leash strap 20 that has been chewed by a pet or that has otherwise been damaged, although replacement may be for any reason, such as attaching a replacement leash strap portion 54 having a desired visual appearance is also contemplated.

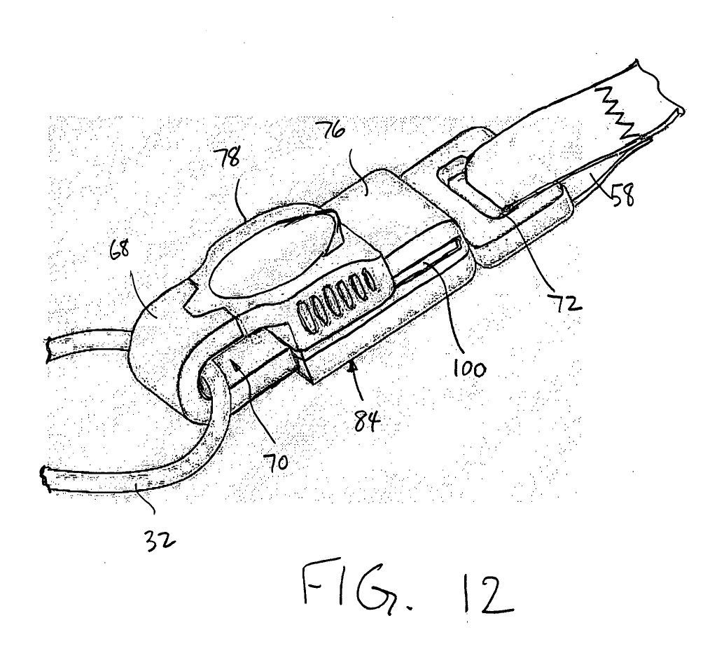

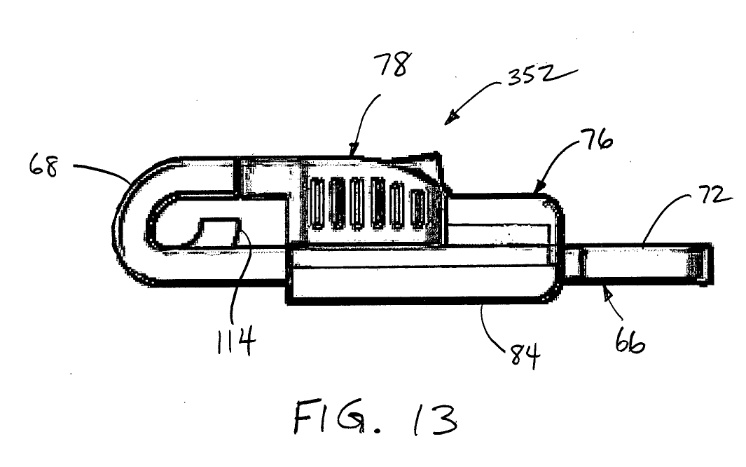

As shown in FIGS. 11 and 12, after the preexisting web material 20 has been removed, the cord 14 is fed through the stop member 18 to expose a loop 32. The closure member 78 is manually moved to the open position and the loop 32 is placed in the opening 70 defined by the hook 68 (FIG. 11). The closure 78 is then released and the spring 106 causes the closure 78 to return to the closed position (FIG. 12). The cord 14 may then be pulled taut until the stop member 18 abuts the connector assembly 52.

To remove the leash assembly 50, the closure 78 is moved to the open position and the loop 32 is disengaged from the hook 68. In this manner, multiple leash assemblies 50 may be exchanged.

For the alternative retractable leash embodiment of FIG. 2, the preexisting leash portion 20 may be removed, e.g., by cutting the loop 36. The closure 78 may be moved to the open position and the ring or loop 44 engaged to the hook 68.

In cases where the retractable leash to be used with the present leash connector embodiment lacks a suitable stop member 18 (FIG. 1) or loop member 44 (FIG. 2), a suitable stop member or ring member may be provided and attached to the free end of the cord 14, e.g., via tying or other attachment means. Additionally, even in the absence a suitable stop member or ring member, a loop or noose may be formed at the free end of the cord 14, e.g., via tying or other attachment means.

The invention has been described with reference to the preferred embodiments. Modifications and alterations will occur to others upon a reading and understanding of the preceding detailed description. For example, the connector assembly may employ a pivoting or telescoping closure in place of the sliding connector. It is intended that the invention be construed as including all such modifications and alterations insofar as they come within the scope of the appended claims or the equivalents thereof.

Having thus described the preferred embodiments, the invention is now claimed to be:

1. A leash repair kit for a retractable leash of a type having a housing and a cord retractably arranged within the housing, the cord having a free end which extends out of the housing, said leash repair kit comprising:
a leash strap; and
a fastening apparatus for removably joining together said cord and said leash strap.

2. The leash repair kit of claim 1, further comprising:
said fastening apparatus including a first end permanently attached to said leash strap and a second end removably attached to said cord.

3. The leash repair kit of claim 2, further comprising:
said leash strap including a loop formed at a first end thereof; and
said fastening apparatus first end defining a slot receiving said loop.

4. The leash repair kit of claim 3, further comprising:
said leash strap including a fastener attached to a second end of said leash strap opposite the first end of said leash strap.

5. The leash repair kit of claim 1, wherein said fastening apparatus includes:
an elongate hook member forming a hook at a first end and having an opening formed in a second end opposite the first end;
a closure carrier mounted to a first surface-of said elongate hook member intermediate the hook and opening; and
a closure member slidably carried on said closure carrier and movable between a closed position and an open position.

6. The leash repair kit of claim 5, further comprising:
one or more bosses attached to said closure carrier and each of said one or more bosses extending at least partially into an aligned boss receptacle formed in said hook member.

7. The leash repair kit of claim 6, further comprising:
a base member mounted to a second surface of said hook member opposite said first surface of said hook member; and
one or more threaded fasteners extending through said base member and rotatably engaging said one or more bosses.

8. A retractable leash, comprising:
a housing;
a cord retractably arranged within said housing, the cord having a free end which extends out of the housing;
a leash strap; and
a fastening apparatus removably joining together said cord and said leash strap.

9. The retractable leash of claim 8, further comprising:
said fastening apparatus including a first end permanently attached to said leash strap and a second end removably attached to said cord.

10. The retractable leash of claim 9, further comprising:
said leash strap including a loop formed at a first end thereof; and
said fastening apparatus first end defining a slot receiving said loop.

11. The retractable leash of claim 10, further comprising:
said leash strap including a fastener attached to a second end opposite said leash strap first end.

12. The retractable leash of claim 8, wherein said fastening apparatus includes:
an elongate hook member forming a hook at a first end and having an opening formed in a second end opposite the first end;
a closure carrier mounted to a first surface of said elongate hook member intermediate the hook and opening; and
a closure member slidably carried on said closure carrier and movable between a closed position and an open position.

13. The retractable leash of claim 12, further comprising:
one or more bosses attached to said closure carrier and each of said one or more bosses extending at least partially into an aligned boss receptacle formed in said hook member.

14. The retractable leash of claim 13, further comprising:
a base member mounted to a second surface of said hook member opposite said first surface of said hook member; and
one or more threaded fasteners extending through said base member and rotatably engaging said one or more bosses.

15. A connector for retractable leash of a type having a housing and a cord retractably arranged within the housing, comprising:
a first fastener adapted to be permanently attached to a external leash strap; and
a second fastener adapted to be removably attached to a free end of the cord.

16. The connector of claim 15, further comprising:
an elongate hook member forming a hook at a first end and having an opening formed in a second end opposite the first end;
a closure carrier mounted to a first surface of said elongate hook member intermediate the hook and opening; and
a closure member slidably carried on said closure carrier and movable between a closed position and an open position.

17. The connector assembly of claim 16, further comprising a spring biasing said closure member to said closed position.

18. A method for replacing an external leash portion of a retractable leash of type having a housing and a cord retractably arranged within said housing, the cord having a free end which extends out of the housing leash, comprising:
providing a replacement leash assembly including a replacement leash and a fastening apparatus for removably joining together said cord and said replacement leash;
removing the external leash portion to be replaced;
forming a loop in the cord free end; and
removably attaching the loop to the fastening apparatus.

19. The method of claim 18, further comprising:
said fastening apparatus including an elongate hook member forming a hook at a first end and having an opening formed in a second end opposite the first end and a mounting plate disposed intermediate the hook and opening; a closure carrier mounted to a first surface of said hook member; and a closure member slidably carried on said closure carrier and movable between a closed position and an open position; and
said removably attaching including manually moving the closure to the open position; securing said loop about said hook; and moving the closure to the closed position.
